(19) United States
(12) Patent Application Publication
(10) Pub. No.: US 2025/0298789 A1
(43) Pub. Date: Sep. 25, 2025

(54) SYSTEM AND METHOD FOR CLOUD-BASED DOCUMENT PROCESSING USING ARTIFICIAL INTELLIGENCE FOR DATA EXTRACTION AND VALIDATION

(71) Applicants: ROHAN KALPESH MARFATIA, Las Vegas, NV (US); TWINKAL ROHAN MARFATIA, Las Vegas, NV (US)

(72) Inventors: ROHAN KALPESH MARFATIA, Las Vegas, NV (US); TWINKAL ROHAN MARFATIA, Las Vegas, NV (US)

(21) Appl. No.: 19/231,809

(22) Filed: Jun. 9, 2025

(51) Int. Cl. G06F 16/23; G06F 16/25

(52) U.S. Cl. CPC G06F 16/2365; G06F 16/254

(57) ABSTRACT

Exemplary embodiments of the present disclosure are directed towards a system for cloud-based document processing using artificial intelligence (AI) for data extraction and validation. The system includes a computing device executing a user interaction and document submission module, enabling users to upload documents with messages, monitor processing progress, and manually review flagged errors. A cloud server communicatively coupled to the computing device, includes a document processing and integration module configured to monitor incoming messages, apply filtering techniques to identify relevant documents based on predefined rules, and process the documents using optical character recognition (OCR) and AI. The system facilitates error flagging for invalid or incomplete data, enables manual correction, and validates corrected data against business rules and external databases. Extracted data is converted into structured formats for system integration, securely stored in a cloud database, and used to generate real-time alerts and reports, enhancing workflow tracking and decision-making efficiency.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates to the field of document processing and management. More specifically, it pertains to a system and method for intelligent, automated document processing leveraging cloud-based technologies and artificial intelligence (AI). The invention focuses on extracting, validating, and integrating data from various document types, including handwritten and typed documents, in a scalable, efficient, and accurate manner using cloud computing platforms. It is particularly applicable to industries requiring high-volume document handling, such as financial services, insurance, healthcare, and government administration.

### BACKGROUND

Traditional document processing systems, particularly in industries such as financial services, insurance, and healthcare, rely heavily on manual data entry and rudimentary Optical Character Recognition (OCR) technologies. While these methods have facilitated a shift from paper-based processes to digital workflows, they are often plagued by inefficiencies, inaccuracies, and scalability challenges.

Manual data entry is inherently labor-intensive, time-consuming, and prone to human error. It requires significant staffing resources and introduces delays in workflows, particularly when handling complex or high-volume tasks, such as processing credit applications or insurance claims. Basic OCR technologies, while capable of digitizing printed text, struggle with handwritten content and poorly formatted documents. These systems frequently produce incomplete or inaccurate data, necessitating manual review and correction.

Moreover, traditional document processing systems lack robust data validation capabilities. Extracted data is rarely verified against external databases or predefined business rules, leading to inconsistencies and errors. This limitation poses significant challenges in industries where compliance, data integrity, and accuracy are critical. Additionally, these systems often operate in isolation, without seamless integration into Customer Relationship Management (CRM) platforms or other external systems, resulting in fragmented workflows and manual data transfer.

The limitations of these methods are further exacerbated by increasing demands for faster, more accurate, and scalable document processing solutions to accommodate growing volumes of data. Organizations face rising pressures to enhance operational efficiency, reduce costs, and meet stringent regulatory and compliance requirements.

In light of these challenges, there is a need for a robust solution that automates document processing with high accuracy and efficiency, minimizes manual intervention, and ensures seamless data validation and integration with external systems. This solution should address the limitations of existing methods by handling diverse document types, including handwritten and typed text, while maintaining compliance with industry standards and business requirements.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and method for cloud-based document processing using artificial intelligence for data extraction and validation.

Another objective of the present disclosure is directed towards automating the extraction, validation, and processing of data from various document types to minimize manual intervention.

Another objective of the present disclosure is directed towards enhancing the accuracy and reliability of document processing by integrating AI-powered data validation techniques.

Another objective of the present disclosure is directed towards facilitating integration with cloud-based services and CRM platforms to streamline workflow management.

Another objective of the present disclosure is directed towards reducing processing time for complex documents by leveraging real-time data extraction and validation technologies.

Another objective of the present disclosure is directed towards ensuring scalability and adaptability to handle high volumes of document processing during peak operational periods.

Another objective of the present disclosure is directed towards improving compliance and data integrity by validating extracted information against external databases and predefined business rules.

Another objective of the present disclosure is directed towards enabling cost-efficient operations by reducing dependency on manual labor and minimizing errors.

Another objective of the present disclosure is directed towards enhancing user experience and customer satisfaction by providing faster and more accurate document processing outcomes.

Another objective of the present disclosure is directed towards automating the document processing workflow, thereby reducing manual intervention and associated errors.

Another objective of the present disclosure is directed towards improving the accuracy of data extraction from both typed and handwritten documents using advanced AI models.

Another objective of the present disclosure is directed towards validating extracted data in real-time against external databases to ensure accuracy and compliance.

Another objective of the present disclosure is directed towards enhancing customer satisfaction by delivering faster, more accurate processing of critical documents.

According to an exemplary aspect of the present disclosure, a system for cloud-based document processing using artificial intelligence for data extraction and validation.

According to another exemplary aspect of the present disclosure, the system includes a computing device comprising a processor and memory, the processor configured to execute instructions from a user interaction and document submission module located within the computing device.

According to another exemplary aspect of the present disclosure, the user interaction and document submission module configured to enable the user to upload documents with along with a message, monitor processing progress, and manually review flagged errors.

According to another exemplary aspect of the present disclosure, a cloud server communicatively coupled to the computing device over a network.

According to another exemplary aspect of the present disclosure, the cloud server includes a document processing and integration module configured to continuously check for incoming messages from the user interaction and document submission module.

According to another exemplary aspect of the present disclosure, the document processing and integration module configured to apply filtering techniques to identify relevant documents based on predefined rules including subject line and sender, and process the identified documents using optical character recognition (OCR) and artificial intelligence to extract data from the documents.

According to another exemplary aspect of the present disclosure, the document processing and integration module configured to trigger error flagging for invalid and incomplete data fields, sending flagged data to the computing device.

According to another exemplary aspect of the present disclosure, the computing device includes the user interaction and document submission module configured to enable the user to manually review and correct errors, further transmitting the corrected data to the document processing and integration module.

According to another exemplary aspect of the present disclosure, the document processing and integration module applies AI techniques to the corrected data to validate and enrich extracted data against predefined business rules and external databases, thereby facilitating data accuracy and completeness.

According to another exemplary aspect of the present disclosure, the document processing and integration module configured to convert the extracted data into structured formats for integration with external systems and securely store processed data in a cloud database.

According to another exemplary aspect of the present disclosure, the document processing and integration module configured to sending real-time alerts and generate reports for document processing status and system performance metrics to the user interaction and document submission module, thereby enabling the user to track workflow efficiency and make data-driven decisions.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1A is a block diagram depicting a schematic representation of a system for cloud-based document processing using artificial intelligence for data extraction and validation, in accordance with one or more exemplary embodiments.

FIG. 1B is an example diagram depicting a schematic representation of a system for cloud-based document processing using artificial intelligence for data extraction and validation, in accordance with one or more exemplary embodiments.

FIG. 2 is a block diagram depicting an embodiment of the user interaction and document submission module on the computing devices, in accordance with one or more exemplary embodiments.

FIG. 3 is a block diagram depicting an embodiment of the document processing and integration module at the server, in accordance with one or more exemplary embodiments.

FIG. 4 is a flow diagram depicting an exemplary method for user interaction and document submission workflow, in accordance with one or more exemplary embodiments.

FIG. 5 is a flow diagram depicting an exemplary method for processing email attachments in the document processing workflow, in accordance with one or more exemplary embodiments.

FIG. 6 is a flow diagram depicting an exemplary method for data extraction and validation, in accordance with one or more exemplary embodiments.

FIG. 7 is a flow diagram depicting an exemplary method for monitoring the email accounts for data extraction and validation, in accordance with one or more exemplary embodiments.

FIG. 8 is a flow diagram depicting an exemplary method for cloud-based document processing using artificial intelligence for data extraction and validation, in accordance with one or more exemplary embodiments.

FIG. 9 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

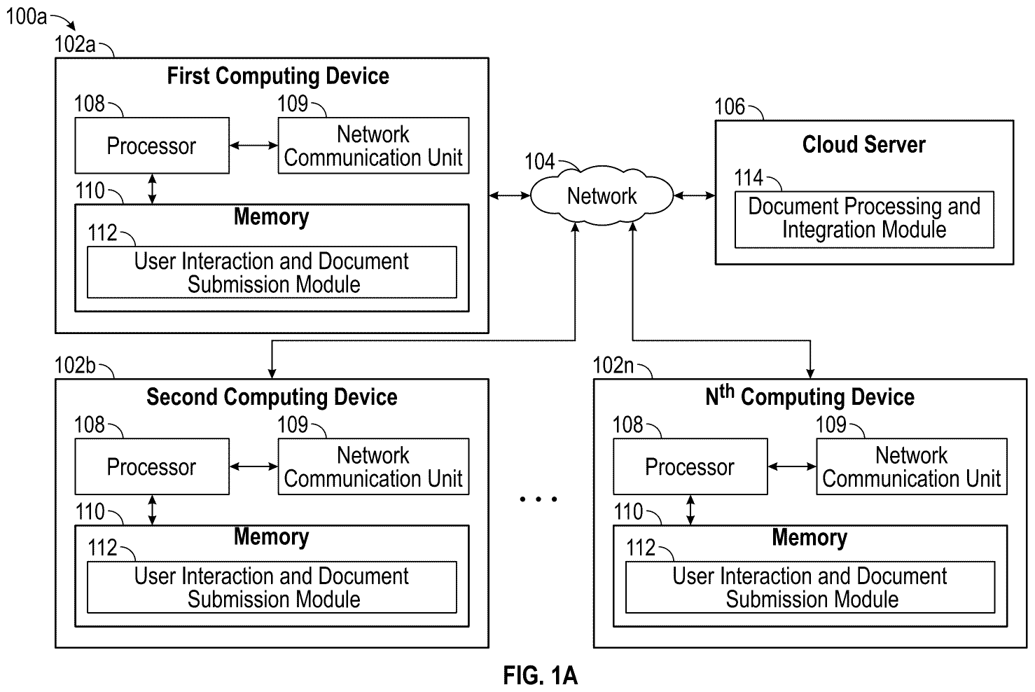

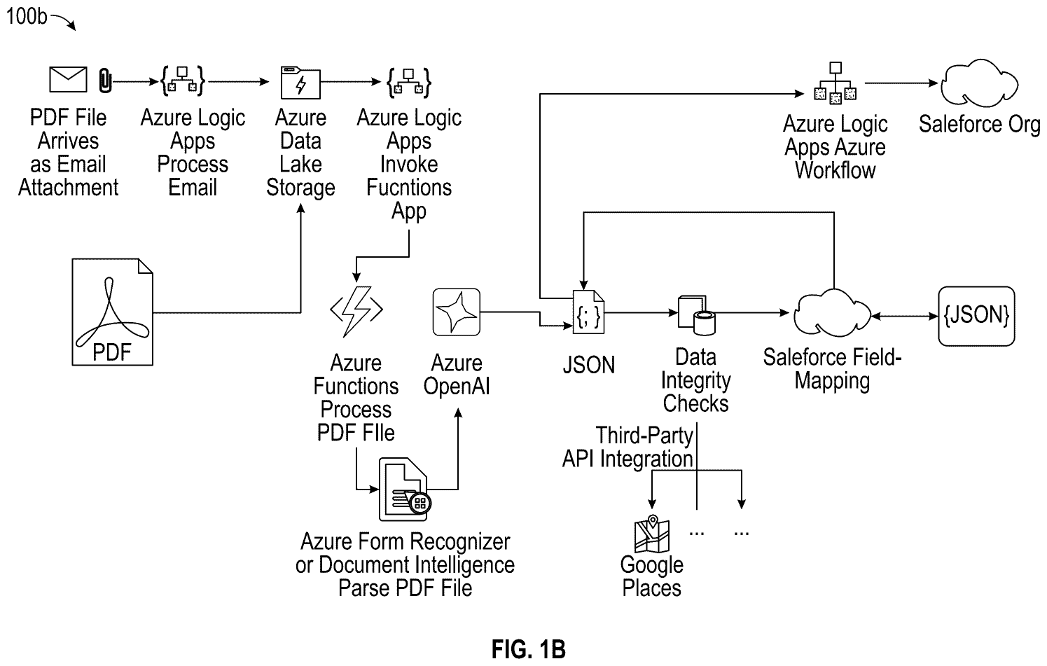

Referring to FIG. 1A is a block diagram 100a depicting a schematic representation of a system for cloud-based document processing using artificial intelligence for data extraction and validation, in accordance with one or more exemplary embodiments. The system 100 includes a first computing device 102a, a second computing device 102b, Nth computing device 102n, a network 104, a cloud server 106, a processor 108, a network communication unit 109, memory 110, a user interaction and document submission module 112, a document processing and integration module 114. The computing devices 102a, 102b . . . 102n includes the first computing device 102a, the second computing device 102b, the Nth computing device 102c. The computing device 102a, 102b . . . 102n may include, but is not limited to, a personal digital assistant, personal computers, a mobile station, computing tablets, a handheld device, an internet enabled calling device, an internet enabled calling software, a telephone, a mobile phone, a digital processing system, and so forth. The computing device (the first computing device, the second computing device, Nth computing device) may include the processor 108 in communication with a memory 112. The processor 108 may be a central processing unit. The memory 112 is a combination of flash memory and random-access memory. The processor 108 may execute instructions and process data within the system, including handling user interactions, performing computations for product price comparisons and storage operations. The network communication unit 109 may be facilitating secure and efficient data exchange between the computing devices 102a, 102b . . . 102n and the cloud server 106 over a network 104. It may be responsible for transmitting requests, receiving responses, and ensuring real-time communication for document processing workflows. The network communication unit 109 may be including protocols to safeguard data integrity and prevent unauthorized access during transmission. The memory 112 may be configured to store program instructions, data, and temporary information needed for system operations.

According to the exemplary embodiment of the present disclosure, the cloud may also include cloud-based delivery models, such as Software as a Service (SaaS), Platform as a Service (PaaS), and Infrastructure as a Service (IaaS).

In accordance to the exemplary embodiment of the present disclosure, the processor 108 may include but not limited to, a microcontroller (for example ARM 7 or ARM 11), a raspberry pi, a microprocessor, a mini CPU, a digital signal processor, a microcomputer, a field programmable gate array, a programmable logic device, a state machine or logic circuitry, arduino board.

The computing device 102 may be communicatively connected to the cloud server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing devices 102a, 102b, 102n are shown in FIG. 1, an embodiment of the system 100 may support any number of computing devices. The computing devices 102a, 102b . . . 102n may be operated by the user. The user may include, but not limited to, the banking admin, banking staff, insurance clerk, healthcare provider, customer and the like. The computing device 102a, 102b . . . 102n supported by the system 100 is realized as a computer-implemented or computer-based device having the hardware or firmware, software, and/or processing logic needed to carry out the computer-implemented methodologies described in more detail herein.

The user interaction and document submission module 112 may be configured to enable the user to upload the document, the document may include but not limited to PDF document, typed text document, handwritten document, linguistic, numerical, graphical, or pictorial forms. The user interaction module 112 may be configured to enable the document processing monitor progress and view the reports.

The user interaction and document submission module 112 may be any suitable applications downloaded from GOOGLE PLAY® (for Google Android devices), Apple Inc.'s APP STORE® (for Apple devices), or any other suitable database. The user interaction and document submission module 112 may be desktop application which runs on Windows or Linux or any other operating system and may be downloaded from a webpage or a CD/USB stick etc. In some embodiments, the user interaction and document submission module 112 may be software, firmware, or hardware that is integrated into the computing device 102. The computing devices 102 may present a web page to the user by way of a browser, wherein the webpage comprises a hyper-link may direct the user to uniform resource locator (URL).

In another exemplary embodiment of the present disclosure, the first computing device, which may be used by a banking administrator or insurance staff, includes an email inbox configured to receive credit application documents submitted by customers or applicants using their devices. The second computing device, which may be used by the customer or applicant, facilitates the submission of these documents, such as loan requests, insurance claims, or other related materials, through email attachments or uploads. The customer's computing device may be a smartphone, tablet, laptop, or desktop computer.

The first computing device communicates with the cloud server through a network to manage document submissions. The cloud server includes a document processing and integration module configured to handle email attachment processing. This process begins with monitoring the administrator's email inbox in real-time, identifying relevant emails based on predefined criteria such as subject keywords or sender domains. Once an email is identified, the system extracts its attachments, which may include PDFs, images, or other supported file formats.

To uphold security and integrity, all attachments may be scanned for malware or other potential risks before processing. The attachments are then pre-processed, where they are assigned unique identifiers for tracking, standardized in format (e.g., converting images to PDFs), and duplicates are removed. After pre-processing, the attachments are temporarily stored in a cloud database, such as Azure Blob Storage or Azure Data Lake Storage, for further operations. Metadata, including sender details, timestamps, and attachment information, may also be logged for auditing and tracking purposes. Subsequent steps in the workflow are triggered automatically, where attachments progress to stages like data extraction and validation. In cases of unsupported formats or corrupted files, the system flags these for manual review and correction by administrative staff using the first computing device.

This setup integrates the administrator's email inbox into the document handling workflow, automating tasks while allowing manual intervention when required. It ensures efficient document processing and improves accuracy by reducing reliance on manual steps.

In an exemplary embodiment of the present disclosure, the system utilizes AI technologies to automate the secure and efficient processing of documents, such as credit applications, loan requests, insurance claims, and other related materials. The system is designed for use in environments like banking or insurance, where administrators manage the intake and processing of customer-submitted documents. The system involves two primary computing devices. The first computing device, typically used by a banking administrator or insurance staff member, includes an email inbox configured to receive credit application documents submitted by customers or applicants. These documents may be sent as email attachments through various submission methods, such as email or file uploads. The second computing device, used by the customer or applicant, may be a smartphone, tablet, laptop, or desktop computer. This device allows the customer to submit documents, such as loan requests or insurance claims, through email attachments or uploads. Once the documents are received, the first computing device communicates with a cloud server via a network to manage document submissions. The cloud server includes an artificial intelligence-powered document processing and integration module, which is responsible for handling the core document operations, including the processing of email attachments. AI features play a crucial role in this stage, as the system uses machine learning algorithms to automatically monitor the administrator's email inbox in real-time and identify relevant emails. AI models can analyze email content, such as subject keywords, sender domains, or document context, to prioritize and recognize important documents. This helps reduce the time spent manually sorting and identifying critical emails. Upon identifying a relevant email, the AI system extracts its attachments, the attachments includes PDFs, images, or other supported file formats and scans these attachments for potential risks like malware or other security threats using AI-based anomaly detection techniques. This enhances security by automatically identifying documents that may be compromised or harmful before further processing. Once the security checks are complete, the system continues to preprocess the attachments using AI algorithms to handle tasks includes assigning unique identifiers to each attachment for tracking purposes. Standardizing the format of documents (e.g., converting images to PDFs), which may involve AI-based optical character recognition (OCR) and image processing to accurately interpret document content. Removing duplicate attachments utilizing AI-based similarity detection to identify and eliminate redundancies in the document repository. The attachments are then temporarily stored in a cloud database such as Azure Blob Storage or Azure Data Lake Storage, ensuring secure storage and accessibility for further processing. Along with the document, metadata, including sender details, timestamps, and attachment information, is logged for auditing and tracking purposes. AI models can also analyze metadata to provide insights into document submission patterns and assist in flagging potential anomalies, further improving workflow automation. After preprocessing, AI models trigger subsequent steps in the workflow, such as data extraction and validation. The system uses AI-powered natural language processing (NLP) and machine learning models to automatically extract relevant information from documents, such as names, addresses, amounts, or policy details. This data is then structured and validated according to predefined criteria, with AI-driven validation checks ensuring accuracy, consistency, and completeness of the extracted data. In cases where documents are in unsupported formats, are corrupted, or fail validation checks, AI flags these attachments for manual review by administrative staff using the first computing device. AI-based models can highlight specific issues within the document such as unreadable text or missing fields allowing the administrator to efficiently review and correct the document. This reduces human error and increases the speed at which issues are identified and addressed.

By integrating artificial intelligence into the workflow, the system can handle a wide variety of documents, formats, and conditions with minimal human intervention. It significantly enhances the accuracy of data extraction and processing, while simultaneously improving the efficiency of document handling by reducing the time and effort spent on manual steps. AI helps in identifying, categorizing, and processing documents intelligently, allowing for real-time responses and faster decision-making.

This AI-powered system not only automates the administrator's email inbox integration into the overall document handling workflow, but it also uses AI to continuously improve and adapt its capabilities. Through machine learning, the system can learn from document submission patterns, improving its classification and extraction capabilities over time. This automated, AI-driven process ensures efficient document processing, enhances security, improves accuracy, and reduces the administrative workload.

Referring to FIG. 1B is an example diagram 100b depicting a schematic representation of a system for cloud-based document processing using artificial intelligence for data extraction and validation, in accordance with one or more exemplary embodiments. This system encompasses a sequence of steps to efficiently process, analyze, and integrate data from documents in a cloud environment, leveraging artificial intelligence technologies for automation and enhanced accuracy.

The workflow begins with the input and data reception stage, where data is typically received in the form of a PDF document. These documents may come through various channels, such as email, direct uploads, or other communication methods. Once the document is received, it moves into the preprocessing and parsing stage. Here, specialized tools and services are employed to handle the initial processing. These services might use Optical Character Recognition (OCR) or other advanced text extraction technologies to convert the content of the document into machine-readable data. The goal at this stage is to transform the raw, unstructured content (like scanned text or images) into structured data, making it suitable for further analysis and integration.

After pre-processing, the data processing phase begins, utilizing Azure services. The structured data is processed through cloud-based services such as Azure Functions or Azure Logic Apps, which handle workflows and automate data operations. These services facilitate tasks like data enrichment, error handling, and workflow orchestration. They also provide scalability, allowing the system to efficiently manage large volumes of incoming data. Depending on the design of the system, the processed data may be temporarily stored in a database or cloud-based data storage service such as Azure Blob Storage or SQL Database. This storage layer ensures that data is securely saved and accessible for further processing, analysis, and integration in subsequent stages.

In the next phase, data mapping and integration, the processed and structured data is integrated with external systems such as Salesforce, allowing for seamless interoperability between various platforms. The data, which has now been structured into a JSON format, is mapped to corresponding fields in Salesforce. This ensures compatibility with the destination system, enabling the efficient exchange of data between the cloud-based document processing system and third-party systems such as customer relationship management (CRM) platforms, financial systems, or enterprise resource planning (ERP) tools.

Once the data is integrated, it moves into the data analysis and output stage. Here, the system leverages advanced analytics tools and visualization platforms like Google Charts or Google Forms to present the processed data in a more digestible and insightful format. The data is visualized through interactive charts, graphs, or forms, making it easier for users to identify trends, patterns, or actionable insights. This stage helps transform raw data into meaningful information, which can be used for reporting, decision-making, or further business processes.

According to the exemplary embodiments of the present disclosure, cloud-based document processing has diverse applications across multiple industries, providing transformative benefits in both current implementations and future advancements. Presently, industries such as financial services and banking leverage this technology to automate the processing of credit applications, loan documents, and financial statements. By extracting and validating data from handwritten and typed documents, these solutions expedite loan approvals, minimize human errors, and ensure compliance with regulatory requirements. In the insurance sector, the technology automates claims processing, underwriting, and policy document management, leading to reduced administrative costs and improved service delivery times. Healthcare providers utilize the solution for automating the processing of medical records, insurance claims, and patient documentation, thereby enhancing operational efficiency and reducing patient waiting times. Government and legal institutions benefit from automated processing of applications, tax filings, and legal forms, improving bureaucratic efficiency and ensuring better regulatory compliance. Similarly, in the e-commerce and retail sectors, the solution streamlines business operations by automating customer service processes, invoice handling, and returns management.

Future advancements in this technology hold significant promise for diverse applications. For instance, AI-driven contract management could enable systems to automatically negotiate, manage, and enforce contracts, flagging inconsistencies and automating renewals or terminations. Integration with chatbots and virtual assistants in customer support could allow for real-time, AI-powered responses to inquiries, further enhancing user experiences. In smart city infrastructure, cloud-based document processing could revolutionize the handling of permits, public service applications, and safety documentation, enabling faster governmental responses. The supply chain industry could see substantial improvements through automated processing of purchase orders, invoices, and shipping documents, ensuring smoother operations and greater efficiency in logistics.

Moreover, the potential for AI-powered document synthesis could allow systems to generate summaries or detailed reports from raw data, creating customized documents such as financial statements or insurance policies, thereby reducing manual efforts. In education and research, this technology could automate the extraction and analysis of information from large datasets and academic papers, significantly enhancing productivity and accelerating research workflows. In the personalized healthcare sector, cloud-based document processing could automate data extraction from medical test results, patient reports, and prescriptions, expediting the processing of test results and reducing administrative burdens on healthcare professionals. By integrating with Electronic Health Records (EHR) and leveraging AI to cross-check medical data, the solution could assist in providing tailored health assessments, ensuring faster, more accurate, and individualized patient care.

According to the exemplary embodiments of the present disclosure, the system provides significant advancements in document processing and workflow automation while offering considerable potential for future innovations in areas such as AI-powered document management, customer interaction, smart city operations, and personalized healthcare. As AI and automation technologies continue to advance, these applications are poised to become essential for enhancing efficiency, accuracy, and scalability across various industries.

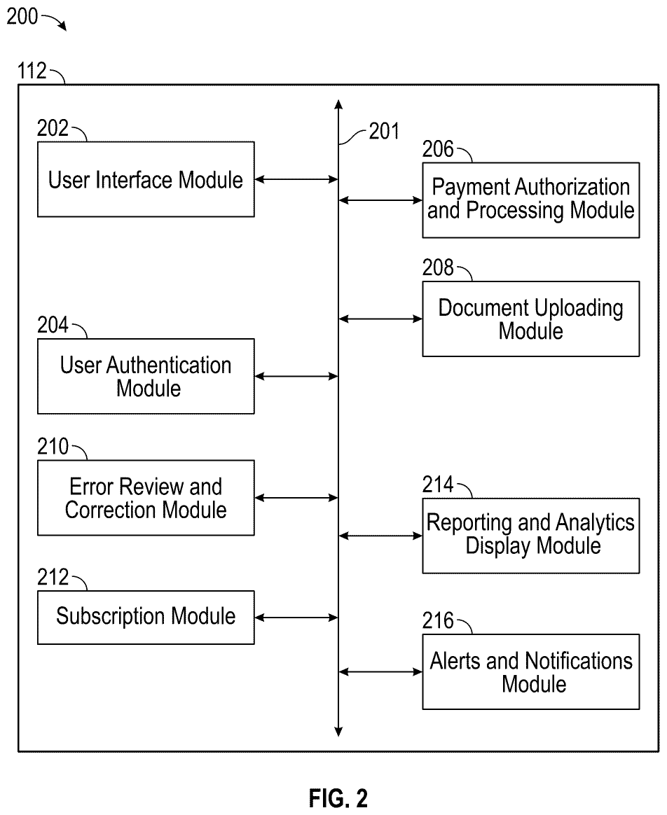

Referring to FIG. 2 is a block diagram 200 depicting an embodiment of the user interaction and submission module 112 on the computing devices 102a, 102b, 102n, in accordance with one or more exemplary embodiments. The user interaction and submission module 112 includes a bus 201, a user interface module 202, a user authentication module 204, a payment authorization and processing module 206, a document uploading module 208, an error review and correction module 210, a subscription module 212, a reporting and analytics viewing module 214, a alerts and notifications module 216. The bus 201 may include a path that permits communication among the modules of the user interaction and submission module 112 installed on the computing device 102. The term “module” is used broadly herein and refers generally to a program resident in the computing device 102. The user interface module 202 provides an interactive platform that may allow users to interact with the system. The user interface module 202 may be configured to facilitate user registration via the user interaction and document submission module 112, installed on one or more computing devices (102a . . . 102n). The user may register by providing basic details, including but not limited to an email address, password, first name, last name, organization information, phone number, and address details. The term organization may refer to, but is not limited to, a bank, insurance company, healthcare center, or similar entity. Furthermore, the user interface module 202 may be configured to transmit the user registration details to the cloud server 106 over the network 104 for storage, authentication, and further processing. The user interface module 202 may enable users to upload documents, track the progress of document processing, and view results and reports. The user interface module 202 may be configured to be intuitive and user-friendly, incorporating features such as real-time status updates, responsive layouts, and streamlined navigation for an efficient user experience.

The user authentication module 204 may be configured to authenticate users on the computing device 102a . . . 102n before granting access to system functionalities. The authentication process may involve validating user credentials, including but not limited to email-password combinations, biometric authentication, or multi-factor authentication (MFA). The user authentication module 204 may communicate with the cloud server 106 over the network 104 to verify user credentials against a centralized authentication database. Upon successful authentication, the system may authorize the user to access features within the user interaction and document submission module 112 based on their subscription status, role-based access control, and predefined security policies. Furthermore, the user authentication module 204 may implement session management mechanisms, including session timeouts, encryption-based credential storage, and handling of multiple failed login attempts to prevent unauthorized access. The user authentication module 204 ensures compliance with security standards and enhances system integrity by enforcing authentication protocols before permitting document submission and processing operations.

The payment authorization and processing module 206 may be configured to enable users to initiate and authorize subscription payments directly from the computing device 102a . . . 102n. The payment authorization and processing module 206 may communicate with provide a user interface module 204 that allows users to select a subscription plan, enter payment credentials, and authorize transactions securely.

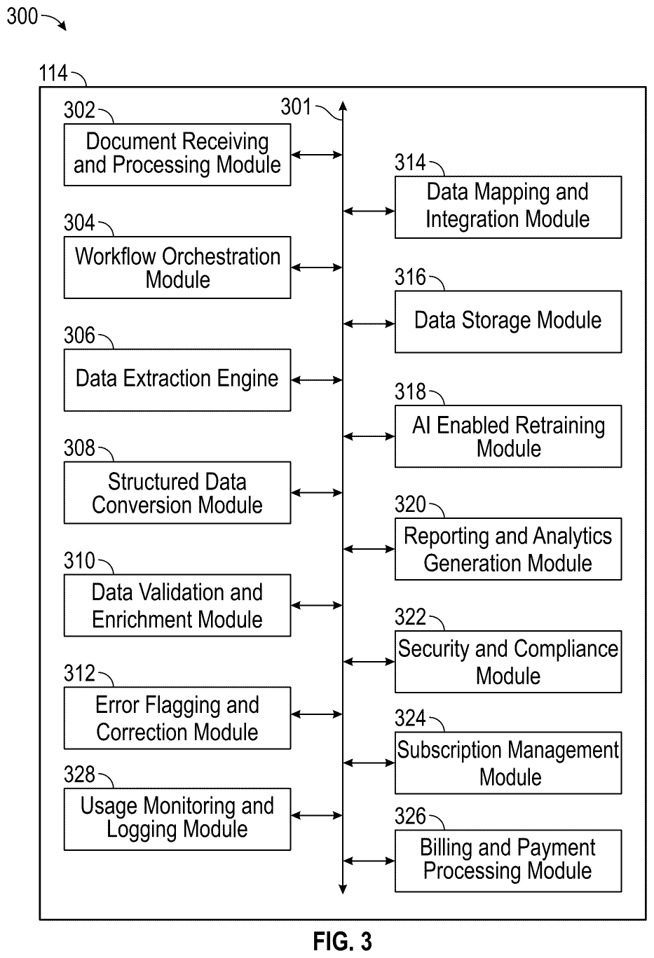

The payment authorization and processing module 206 may support multiple payment methods, including but not limited to credit cards, debit cards, net banking, UPI, digital wallets, and corporate billing accounts. The payment authorization and processing module 206 may be communicatively coupled with the billing and payment processing module 326 on the cloud server 106 (As shown in FIG. 3) to transmit payment details over the Network 104, verify transactions, and update the subscription management module 324 (As shown in FIG. 3) upon successful payment completion.

For enhanced security, the payment authorization and processing module 206 may implement multi-factor authentication (MFA), encryption-based data transmission, and tokenization techniques to safeguard financial data. Additionally, it may provide users with access to billing summaries, payment history, invoices, and automated renewal options to facilitate subscription management. In the event of a failed payment transaction, the payment authorization and processing module 206 may prompt the user to retry the payment, update payment details, or select an alternative payment method. The payment authorization and processing module 206 may also trigger notifications through the alerts and notifications module 214, informing the user about payment status, upcoming due dates, and subscription expirations.

The document uploading module 208 may facilitate the submission of documents, including but not limited to PDFs, scanned images, handwritten documents, and typed text documents, for processing. It may support a variety of file formats to ensure compatibility and provide features such as drag-and-drop functionality, real-time upload progress indicators, and automated validation of files before submission. The document uploading module 208 may be configured to streamline and ensure an error-free document submission process. The error review and correction module 210 may enable manual review and rectification of flagged errors in the extracted data. It may provide tools for users to verify and correct discrepancies in fields where inconsistencies are detected, ensuring high accuracy and reliability in the final output. The error review and correction module 210 may be configured to communicate with the cloud server 106, which may host the data extraction and validation engine, for processing documents. The error review and correction module 210 may visually highlight specific fields requiring attention, allowing users to perform corrections efficiently within a guided system interface.

The subscription module 212 may be configured to manage user subscriptions and regulate access to system features based on the validity of the subscription plan. The subscription module 212 may facilitate various subscription-related operations, including activation, renewal, upgrades, downgrades, and cancellations, ensuring compliance with predefined service agreements. It may also be communicatively coupled with the payment authorization and processing module 206 to verify successful payment transactions before activating or renewing a subscription. Additionally, the subscription module 212 may interface with the subscription management module 324 on the cloud server 106 to synchronize subscription data across the system. To enforce access control, the subscription module 212 may restrict users from processing documents or utilizing certain functionalities upon subscription expiry. If a subscription lapses, the module may disable document processing features and trigger alerts or renewal prompts via the alerts and notifications module 216. The module may further store and update essential subscription details, including the type of subscription plan (e.g., basic, premium, enterprise), validity period (e.g., monthly, annually), payment status, and user access permissions based on the subscribed plan. In addition to standard subscription management, the subscription module 212 may support trial periods, promotional offers, and discounts, enabling users to evaluate the system before purchasing a full subscription.

The reporting and analytics viewing module 214 may allow users, such as but not limited to banking administrators, insurance staff, and healthcare providers, to access comprehensive reports and analytics generated from processed data. It may present insights through organized, visually engaging tools such as charts, graphs, and detailed summaries. The reporting and analytics viewing module 208 may enhance decision-making by offering actionable insights, tracking workflow performance metrics, and providing a high-level overview of system efficiency.

The reporting and analytics viewing module 214 may be configured to track, analyze, and present user activity metrics related to document processing operations. It may collect data on parameters such as the number of documents processed, number of pages processed, processing time, and system usage trends. The reporting and analytics viewing module 214 may retrieve usage data from the cloud server 106 over the network 104 and display analytical insights through a user interface module 202 within the user interaction and document submission module 112. Additionally, it may generate detailed reports for users and administrators/service provider, assisting in subscription management, billing accuracy, and operational efficiency. Furthermore, the reporting and analytics viewing module 214 may be configured to send periodic usage reports to the service provider, ensuring transparency and facilitating data-driven decision-making.

Referring to FIG. 3 is a block diagram 300 depicting an embodiment of the document processing and integration module at the server, in accordance with one or more exemplary embodiments. The document processing and integration module includes a bus 301, a document receiving and processing module 302, a workflow orchestration module 304, a data extraction engine 306, a structured data conversion module 308, a data validation and enrichment module 310, an error flagging and correction module 312, a data mapping and integration module 314, a data storage module 316, an AI-enabled retraining module 318, a reporting and analytics generation module 320, and a security and compliance module 322, a subscription management module 324, a billing and payment processing module 326, and a usage monitoring and logging module 328.

The document receiving and processing module 302 may be configured to receive documents from various sources, such as email attachments, API calls, or direct uploads. It ensures that documents are categorized, tagged, and formatted consistently for downstream processing. It performs preprocessing steps such as file type recognition, duplication checks, and secure storage in systems like Azure Blob Storage or Data Lake.

The workflow orchestration module 304 may be configured to coordinate the execution of tasks across all modules. By using cloud computing tools, may include but not limited to Azure Logic Apps, it automates task sequencing, monitors progress, and ensures error handling. The workflow orchestration module 304 integrates tightly with other modules, enabling efficient communication and execution. It also ensures that dependencies are managed effectively, reducing processing delays and optimizing resource usage.

The data extraction engine 306 may be configured to utilize Optical Character Recognition (OCR) in combination with Artificial Intelligence (AI). The AI-powered tools may include, but are not limited to, Azure Form Recognizer and OpenAI models, to extract structured data from scanned, handwritten, or typed documents. It identifies key fields, such as names, addresses, dates, and signatures. By leveraging advanced AI algorithms, it achieves high accuracy even for poorly formatted or handwritten text, preparing the data for conversion and validation. The structured data conversion module 308 may be configured to convert the extracted raw data into structured formats, such as JSON or XML.

The structured data conversion module 308 may be configured to ensure that the data adheres to predefined schemas required for validation and integration. It may also prepare the data for further automated processing, eliminating ambiguities and inconsistencies. The data validation and enrichment module 310 may be configured to validate the structured data against predefined business rules and external databases, such as the Google Places API for address verification. This module may enrich the data by augmenting incomplete information or correcting inconsistencies, thereby ensuring data accuracy, compliance with business standards, and readiness for integration. The error flagging and correction module 312 may be configured to identify errors or incomplete data. It flags such entries and routes them for human review. A human-in-the-loop mechanism allows administrative users to correct or approve flagged data. Once corrected, the data is reintegrated into the workflow, ensuring accuracy without halting the automation process. The data mapping and integration module 314 may be configured to map the validated data to custom fields in external systems, such as Salesforce, using API integrations like MuleSoft. This module ensures seamless data transfer while maintaining data integrity. It also supports two-way synchronization, allowing for real-time updates and providing a unified view of customer applications. The data storage module 316 may be configured to store both processed and unprocessed data in databases, such as Azure Data Lake and Blob Storage. It ensures scalable and reliable storage while facilitating easy retrieval for audits, reporting, and future processing.

The data storage module 316 complies with data retention policies and regulatory standards. The AI-enabled retraining module 318 may be configured to receive corrections and flagged errors from the error flagging and correction module. It may also retrain AI models to improve their accuracy and efficiency. The AI-enabled retraining module 318 employs feedback loops to enhance the system's ability to handle new and complex document types, ensuring continuous improvement. The reporting and analytics generation module 320 may be configured to generate reports and analytics on system performance, document processing times, and error rates. It provides actionable insights to administrators, helping them monitor workflows and optimize operations. Additionally, the reporting and analytics generation module 320 may communicate with the computing device, which includes the user interaction and submission module (as shown in FIG. 1), to enable users to view real-time reporting for better decision-making. The security and compliance module 322 may be configured to provide data security and compliance throughout the system. It ensures that all modules adhere to data protection regulations, such as GDPR or HIPAA. The security and compliance module 322 may provide features that include encryption, access controls, audit logging, and regular security assessments to safeguard sensitive information.

The billing and payment processing module 324 may be configured to manage financial transactions related to user subscriptions. The billing and payment processing module 324 may generate billing invoices, process subscription payments, and verify payment status before granting or restricting access to system functionalities. The billing and payment processing module 324 may integrate with third-party payment gateways to facilitate transactions via multiple payment methods, including but not limited to credit cards, debit cards, net banking, upi, and digital wallets. Upon successful payment, the module may update the subscription management module 324 to reflect the renewed subscription status. The billing and payment processing module 324 may also handle failed transactions, refunds, chargebacks, and payment disputes, ensuring compliance with financial regulations. additionally, the module may provide users with access to billing history, payment receipts, and automated reminders for upcoming renewals.

The usage monitoring and logging module 328 may be configured to track and record user activities related to document processing operations. The usage monitoring and logging module may log details such as the number of documents processed, the number of pages processed, timestamps, user actions, and system events. The usage monitoring and logging module 328 may communicate with the reporting and analytics viewing module 214 to generate real-time usage analytics for users and administrators. Additionally, it may transmit aggregated usage reports to the service provider, ensuring transparency and enabling data-driven decision-making. The usage monitoring and logging module 328 may also support audit logging, tracking security-related events such as authentication attempts, failed login attempts, and unauthorized access attempts. This ensures compliance with regulatory requirements and enhances system security and operational efficiency.

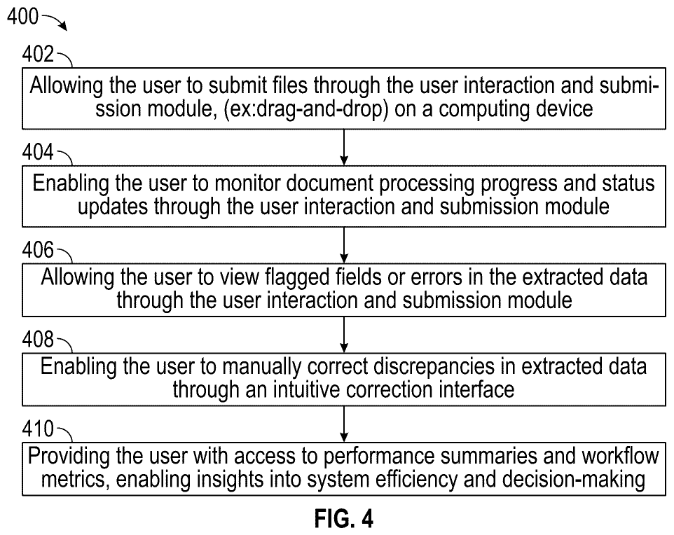

Referring to FIG. 4 is a flow diagram 400 depicting an exemplary method for user interaction and document submission workflow, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method 400 commences at step 402, allowing the user to submit files through the user interaction and submission module, (ex: drag-and-drop) on a computing device. Thereafter at step 404, enabling the user to monitor document processing progress and status updates through the user interaction and submission module. Thereafter at step 406, allowing the user to view flagged fields or errors in the extracted data through the user interaction and submission module. Thereafter at step 408, enabling the user to manually correct discrepancies in extracted data through an intuitive correction interface. Thereafter at step 410, providing the user with access to performance summaries and workflow metrics, enabling insights into system efficiency and decision-making.

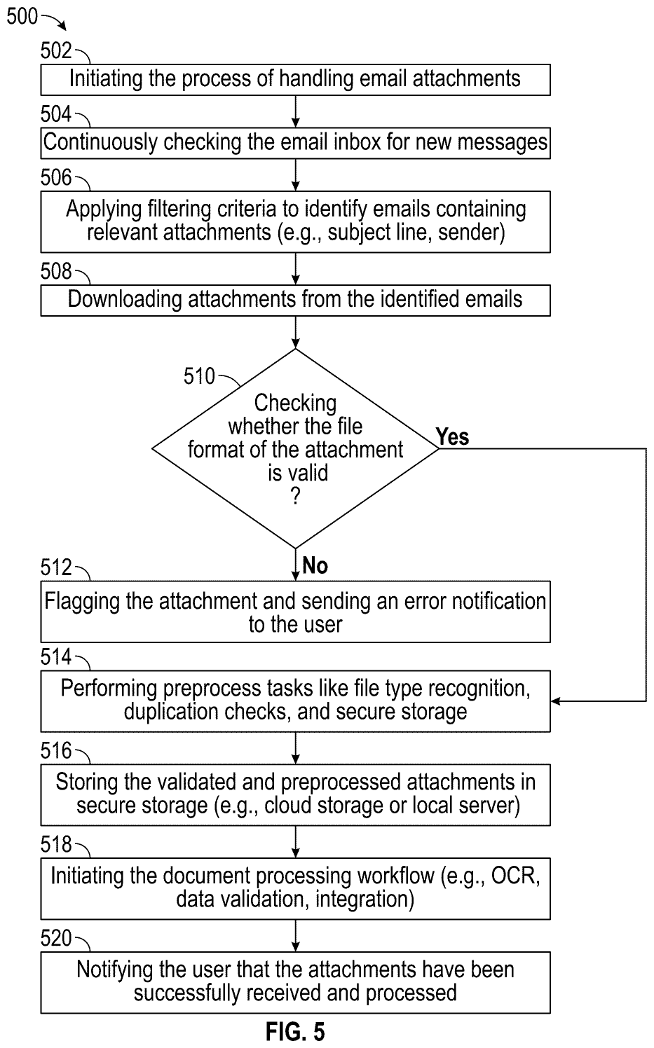

Referring to FIG. 5 is a flow diagram 500 depicting an exemplary method for processing email attachments in the document processing workflow, in accordance with one or more exemplary embodiments. The method 500 may be carried out in the context of the details of FIG. 1, FIG. 2, FIG. 3 and FIG. 4. However, the method 500 may also be carried out in any desired environment. Further, the aforementioned definitions may equally apply to the description below. The method 500 commences at step 502, initiating the process of handling email attachments. Thereafter at step 504, continuously checking the email inbox for new messages. Thereafter at step 506, applying filtering criteria to identify emails containing relevant attachments (e.g., subject line, sender). Thereafter at step 508, downloading attachments from the identified emails. Checking whether the file format of the attachment is valid at step 510. If the answer to step 510 is NO, the method continuous at step 512, flagging the attachment and sending an error notification to the user. If the answer to step 510 is YES, the method continuous at step 514, performing preprocessing tasks like file type recognition, duplication checks, and secure storage. Thereafter at step 516, storing the validated and preprocessed attachments in secure storage (e.g., cloud storage or local server). Thereafter at step 518, initiating the document processing workflow (e.g., OCR, data validation, integration). Thereafter at step 520, notifying the user that the attachments have been successfully received and processed.

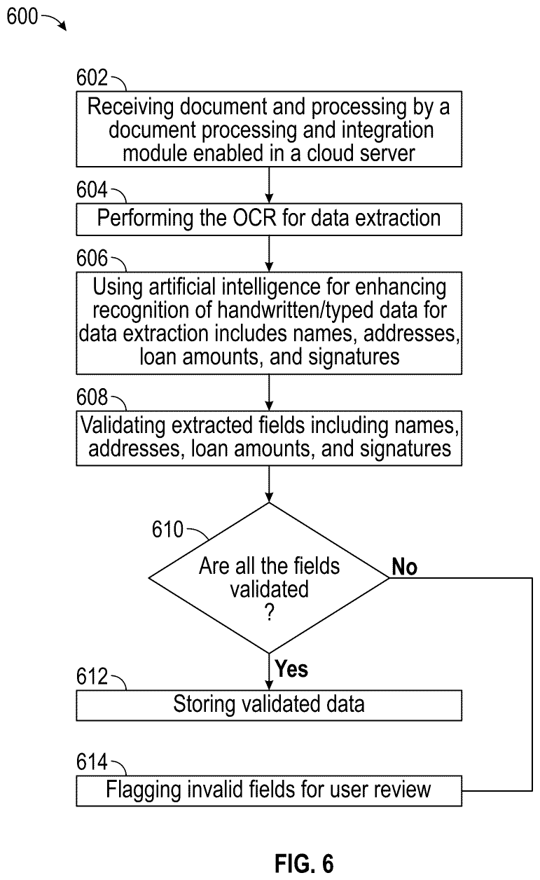

Referring to FIG. 6 is a flow diagram 600 depicting an exemplary method for data extraction and validation, in accordance with one or more exemplary embodiments. The method 600 may be carried out in the context of the details of FIG. 1, FIG. 2, FIG. 3, FIG. 4 and FIG. 5. However, the method 600 may also be carried out in any desired environment. Further, the aforementioned definitions may equally apply to the description below. The method 600 commences at step 602, receiving document and processing by a document processing and integration module enabled in the cloud server. Thereafter at step 604, performing the OCR for data extraction. Thereafter at step 606, using artificial intelligence for enhancing recognition of handwritten/typed data for data extraction includes names, addresses, loan amounts, and signatures. Thereafter at step 608, validating extracted fields including names, addresses, loan amounts, and signatures. Checking all the fields are validated? at step 610. If the answer to step 610 is YES, the method continuous at step 612, storing validated data. If the answer to step 614 is NO, Sending the flagging invalid fields for user review.

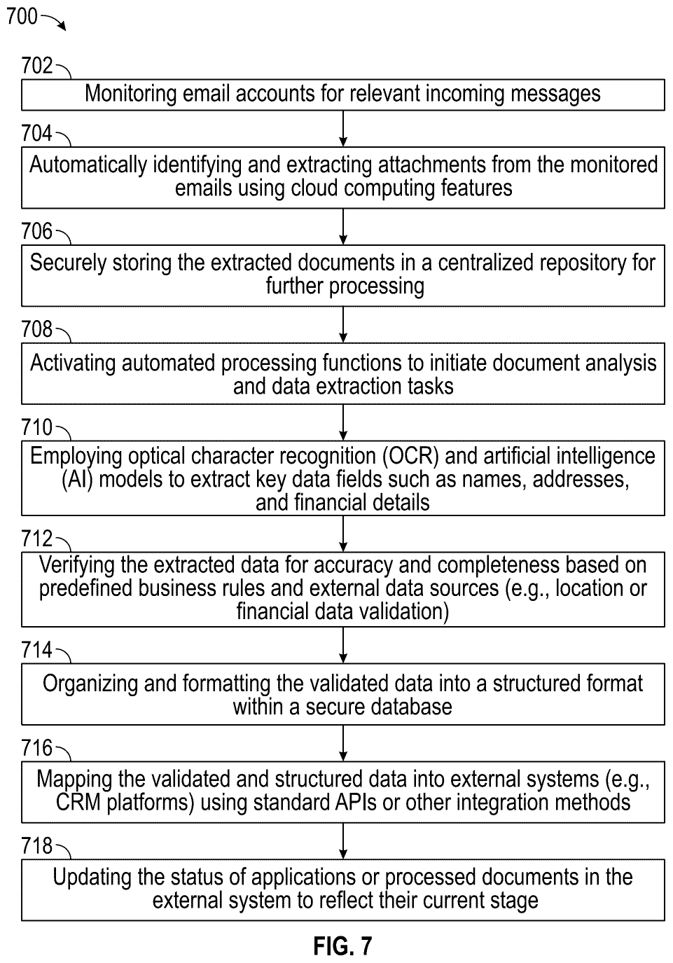

Referring to FIG. 7 is a flow diagram 700 depicting an exemplary method for monitoring the email accounts for data extraction and validation, in accordance with one or more exemplary embodiments. The method 700 may be carried out in the context of the details of FIG. 1, FIG. 2, FIG. 3, FIG. 4, FIG. 5 and FIG. 6. However, the method 700 may also be carried out in any desired environment. Further, the aforementioned definitions may equally apply to the description below.

The method commences at step 702, monitoring email accounts for relevant incoming messages. Thereafter at step 704, automatically identifying and extracting attachments from the monitored emails using cloud computing features. Thereafter at step 706, securely storing the extracted documents in a centralized repository (cloud database) for further processing. Thereafter at step 708, activating automated processing functions to initiate document analysis and data extraction tasks. Thereafter at step 710, employing Optical Character Recognition (OCR) and artificial intelligence (AI) models to extract key data fields such as names, addresses, and financial details. Thereafter at step 712, verifying the extracted data for accuracy and completeness based on predefined business rules and external data sources (e.g., location or financial data validation). Thereafter at step 714, organizing and formatting the validated data into a structured format within a secure database. Thereafter at step 716, mapping the validated and structured data into external systems (e.g., CRM platforms) using standard APIs or other integration methods. Thereafter at step 718, updating the status of applications or processed documents in the external system to reflect their current stage.

In accordance with an exemplary embodiment of the invention, the system incorporates a subscription and payment management objective that regulates user access based on the validity of their subscription. Upon the expiry of a subscription, the system restricts the user's ability to process documents, ensuring compliance with the established payment terms. This functionality is integrated into the platform's workflow, with continuous monitoring of the subscription status. If a subscription expires, the system automatically disables document upload and processing features and notifies the user of the requirement to renew the subscription. This mechanism is designed to safeguard the operational integrity of the system and ensure alignment with the client's business model.

In accordance to the exemplary embodiment of the invention, the system may be configured to send information to the service provider regarding the number of documents processed by the user. This feature may provide the service provider with detailed usage data, which can be used for billing, monitoring, or improving the service offering. By sharing this information, the system enhances transparency and supports operational accountability, aligning usage with subscription plans or service agreements.

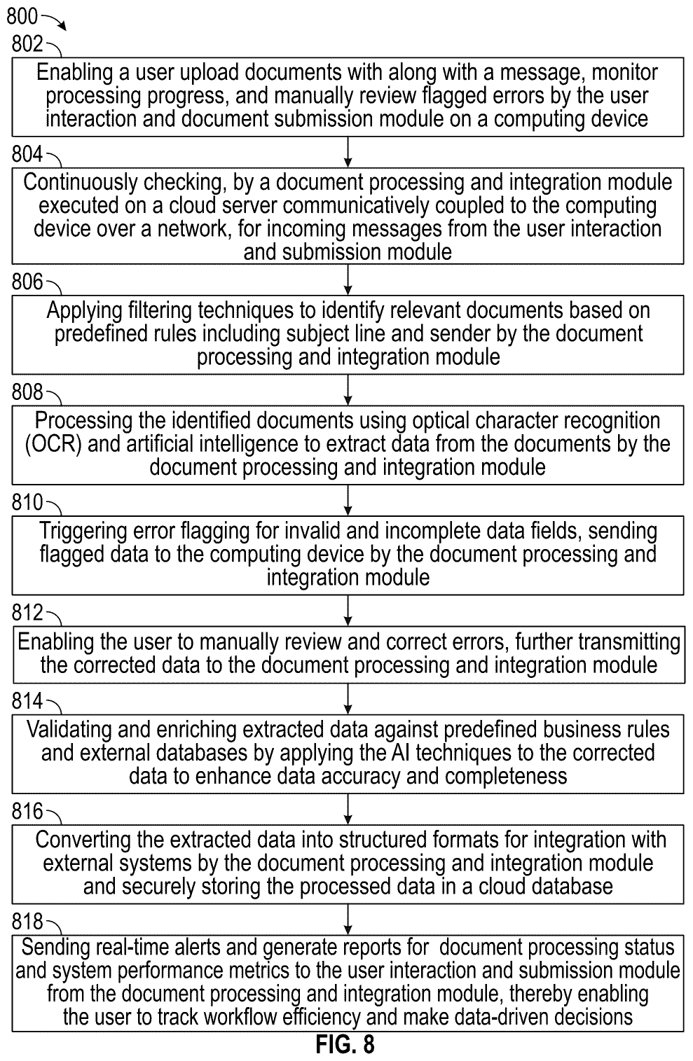

Referring to FIG. 8 is a flow diagram 800 depicting an exemplary method for cloud-based document processing using artificial intelligence for data extraction and validation, in accordance with one or more exemplary embodiments. The method 800 may be carried out in the context of the details of FIG. 1, FIG. 2, FIG. 3, FIG. 4, FIG. 5, FIG. 6 and FIG. 7. However, the method 800 may also be carried out in any desired environment. Further, the aforementioned definitions may equally apply to the description below.

The method 800 commences at step 802, enabling a user upload documents with along with a message, monitor processing progress, and manually review flagged errors by the user interaction and document submission module on a computing device. Thereafter at step 804, continuously checking, by a document processing and integration module executed on a cloud server communicatively coupled to the computing device over a network, for incoming messages from the user interaction and document submission module. Thereafter at step 806, applying filtering techniques to identify relevant documents based on predefined rules including subject line and sender by the document processing and integration module. Thereafter at step 808, processing the identified documents using optical character recognition (OCR) and artificial intelligence to extract data from the documents by the document processing and integration module. Thereafter at step 810, triggering error flagging for invalid and incomplete data fields, sending flagged data to the computing device by the document processing and integration module. Thereafter at step 812, enabling the user to manually review and correct errors, further transmitting the corrected data to the document processing and integration module. Thereafter at step 814, validating and enriching extracted data against predefined business rules and external databases by applying the AI techniques to the corrected data to enhance data accuracy and completeness. Thereafter at step 816, converting the extracted data into structured formats for integration with external systems by the document processing and integration module and securely storing the processed data in a cloud database. Thereafter at step 818, sending real-time alerts and generate reports for document processing status and system performance metrics to the user interaction and document submission module from the document processing and integration module thereby enabling the user to track workflow efficiency and make data-driven decisions.

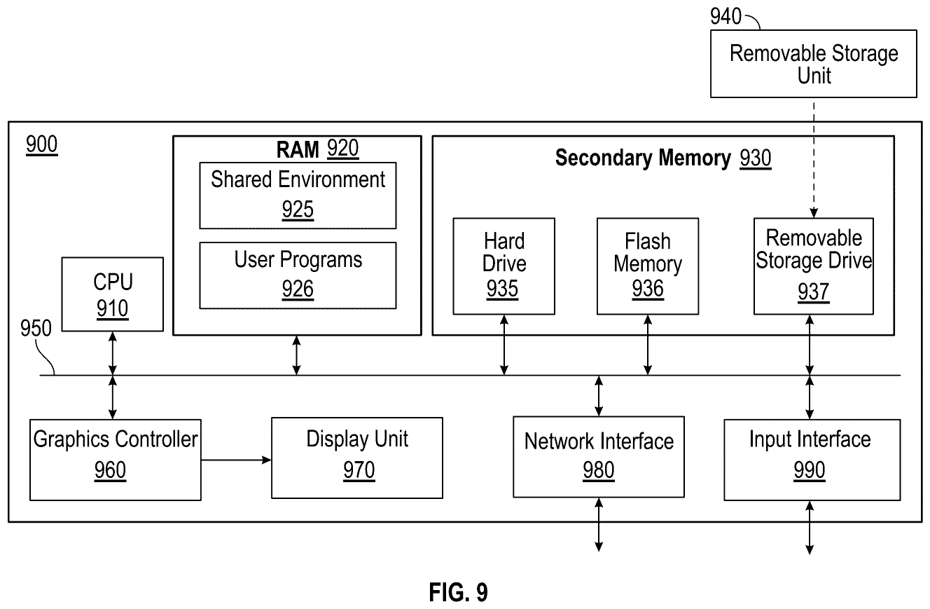

Referring to FIG. 9 is a block diagram 900 illustrating the details of a digital processing system 900 in which various aspects of the present disclosure are operative by execution of appropriate software instructions. The Digital processing system 900 may correspond to the computing device 102a, 102b . . . 102n (or any other system in which the various features disclosed above can be implemented).

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions, such as those used in threads and stacks, constituting shared environment 925 and/or user programs 926. Shared environment 925 includes operating systems, device drivers, virtual machines, etc., which provide a (common) run time environment for execution of user programs 926.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with other systems (such as those shown in FIG. 1) connected to the network 104.

Secondary memory 930 may contain hard drive 935, flash memory 936, and removable storage drive 937. Secondary memory 930 may store the data software instructions (e.g., for performing the actions noted above with respect to the Figures), which enable digital processing system 900 to provide several features in accordance with the present disclosure.

Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EEPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 950. Transmission media can also take the form of acoustic or light waves, such as those generated during radio-wave and infra-red data communications.

According to an exemplary aspect of the present disclosure, the processor executes instructions from the user interaction and document submission module, the user interaction and document submission module configured to enable the user to upload document including loan request applications, insurance claim forms, health records, invoice files, legal documents, and business operation documents.

According to another exemplary aspect of the present disclosure, the processor executes instructions from the user interaction and document submission module, the user interaction and document submission module configured to enable the user to send the upload document along with the message, the message including email message.

According to another exemplary aspect of the present disclosure, the message is an email message, and the document is an attachment included in the email message.

According to another exemplary aspect of the present disclosure, the user comprising a customer, a healthcare provider, banking admin, insurance staff.

According to another exemplary aspect of the present disclosure, the server executes instructions from the document processing and integration module, the document processing and integration module comprising a document receiving and processing module is configured to perform pre-processing tasks including file type recognition and duplication checks before initiating document processing.

According to another exemplary aspect of the present disclosure, the server executes instructions from the document processing and integration module, the document processing and integration module comprising a workflow orchestration module is configured to automatically manage task sequencing and monitor the progress of document processing tasks.

According to another exemplary aspect of the present disclosure, the server executes instructions from the document processing and integration module, the document processing and integration module is configured to support multiple document formats such as PDFs, images, and handwritten documents.

According to another exemplary aspect of the present disclosure, the server executes instructions from the document processing and integration module, the document processing and integration module comprising a data extraction engine is configured to utilize optical character recognition (OCR) and artificial intelligence techniques for data extraction from handwritten, typed documents, PDF documents, and images.

According to another exemplary aspect of the present disclosure, the server executes instructions from the document processing and integration module, the document processing and integration module comprising a data validation and enrichment module is configured to verify the extracted data against predefined business rules and external data sources integration with third part APIs includes Google APIs for real-time verification.

According to another exemplary aspect of the present disclosure, the server executes instructions from the document processing and integration module, the document processing and integration module comprising a data mapping and integration module configured to map validated data to external systems such as CRM platforms via API integrations.

According to another exemplary aspect of the present disclosure, the server executes instructions from the document processing and integration module, the document processing and integration module comprising an error flagging and correction module is configured to identify and flag discrepancies in the extracted data and route them to the user computing device for manual correction.

According to another exemplary aspect of the present disclosure, the processor executes instructions from the user interaction and document submission module, the user interaction and document submission module comprising user interface module configured to display flagged fields in an intuitive interface for user review and manual correction.

According to another exemplary aspect of the present disclosure, the processor executes instructions from the user interaction and document submission module, the user interaction and document submission module comprising an error review and correction module is configured to enable the user to perform manual review and rectification of flagged errors in the extracted data.

According to another exemplary aspect of the present disclosure, the server executes instructions from the document processing and integration module, the document processing and integration module comprising a structured data conversion module is configured to convert the extracted data into structured formats.

According to another exemplary aspect of the present disclosure, the server executes instructions from the document processing and integration module, the document processing and integration module comprising a data storage module configured to securely store processed data in the cloud database.

According to another exemplary aspect of the present disclosure, the server executes instructions from the document processing and integration module, the document processing and integration module comprising a reporting and analytics generation module is configured to generate real-time performance reports on document processing efficiency and error rates.

According to another exemplary aspect of the present disclosure, the server executes instructions from the document processing and integration module, the document processing and integration module comprising an AI-enabled retraining module is configured to enhance the accuracy of AI models by retraining them with feedback data from user corrections and flagged errors.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for cloud-based document processing using artificial intelligence for data extraction and validation, comprising:
a computing device comprising a processor and memory, the processor configured to execute instructions from a user interaction and document submission module located within the computing device, wherein the user interaction and document submission module configured to enable the user to upload documents along with a message, monitor processing progress, and manually review flagged errors;
a cloud server communicatively coupled to the computing device over a network, wherein the cloud server comprises a document processing and integration module configured to continuously check for incoming messages from the user interaction and document submission module, apply filtering techniques to identify relevant documents based on predefined rules including subject line and sender, and process the identified documents using optical character recognition (OCR) and artificial intelligence to extract data from the documents;
the document processing and integration module configured to trigger error flagging for invalid and incomplete data fields, sending flagged data to the computing device, wherein the computing device comprises the user interaction and document submission module configured to enable the user to manually review and correct errors, further transmitting the corrected data to the document processing and integration module, wherein the document processing and integration module applies AI techniques to the corrected data to validate and enrich extracted data against predefined business rules and external databases, thereby ensuring data accuracy and completeness;
the document processing and integration module configured to convert the extracted data into structured formats for integration with external systems and securely store processed data in a cloud database; and
the document processing and integration module configured to send real-time alerts and generate reports for document processing status and system performance metrics to the user interaction and document submission module, thereby enabling the user to track workflow efficiency and make data-driven decisions.

2. The system of claim 1, wherein the processor executes instructions from the user interaction and document submission module, the user interaction and document submission module configured to enable the user to upload document including loan request applications, insurance claim forms, health records, invoice files, legal documents, business operation documents.

3. The system of claim 1, wherein the processor executes instructions from the user interaction and document submission module, the user interaction and document submission module configured to enable the user to send the upload document along with the message, the message including email message.

4. The method of claim 1, wherein the message is an email message, and the document is an attachment included in the email message.

5. The system of claim 1, wherein the user comprising a customer, a healthcare provider, banking admin, insurance staff.

6. The system of claim 1, wherein the cloud server executes instructions from the document processing and integration module, the document processing and integration module comprising a document receiving and processing module is configured to perform pre-processing tasks including file type recognition and duplication checks before initiating document processing.

7. The system of claim 1, wherein the cloud server executes instructions from the document processing and integration module, the document processing and integration module comprising a workflow orchestration module is configured to automatically manage task sequencing and monitor the progress of document processing tasks.

8. The system of claim 1, wherein the cloud server executes instructions from the document processing and integration module, the document processing and integration module is configured to support multiple document formats such as PDFs, images, and handwritten documents.

9. The system of claim 1, wherein the cloud server executes instructions from the document processing and integration module, the document processing and integration module comprising a data extraction engine is configured to utilize optical character recognition (OCR) and artificial intelligence techniques for data extraction from handwritten, typed documents, PDF documents, and images.

10. The system of claim 1, wherein the cloud server executes instructions from the document processing and integration module, the document processing and integration module comprising a data validation and enrichment module is configured to verify the extracted data against predefined business rules and external data sources integration with third part APIs includes Google APIs for real-time verification.

11. The system of claim 1, wherein the cloud server executes instructions from the document processing and integration module, the document processing and integration module comprising a data mapping and integration module is configured to map validated data to external systems such as CRM platforms via API integrations.

12. The system of claim 1, wherein the cloud server executes instructions from the document processing and integration module, the document processing and integration module comprising an error flagging and correction module is configured to identify and flag discrepancies in the extracted data and route them to the user computing device for manual correction.

13. The system of claim 1, wherein the processor executes instructions from the user interaction and document submission module, the user interaction and document submission module comprising user interface module is configured to display flagged fields in an intuitive interface for user review and manual correction.

14. The system of claim 1, wherein the processor executes instructions from the user interaction and document submission module, the user interaction and document submission module comprising an error review and correction module is configured to enable the user to perform manual review and rectification of flagged errors in the extracted data.

15. The system of claim 1, wherein the cloud server executes instructions from the document processing and integration module, the document processing and integration module comprising a structured data conversion module is configured to convert the extracted data into structured formats.

16. The system of claim 1, wherein the cloud server executes instructions from the document processing and integration module, the document processing and integration module comprising a data storage module is configured to securely store processed data in the cloud database.

17. The system of claim 1, wherein the cloud server executes instructions from the document processing and integration module, the document processing and integration module comprising a reporting and analytics generation module is configured to generate real-time performance reports on document processing efficiency and error rates.

18. The system of claim 1, wherein the cloud server executes instructions from the document processing and integration module, the document processing and integration module comprising an AI-enabled retraining module is configured to enhance the accuracy of AI models by retraining them with feedback data from user corrections and flagged errors.

19. A method for cloud-based document processing using artificial intelligence for data extraction and validation, the method comprising:
enabling a user upload documents with along with a message, monitor processing progress, and manually review flagged errors by the user interaction and document submission module on a computing device;
continuously checking by a document processing and integration module executed on a cloud server communicatively coupled to the computing device over a network, for incoming messages from the user interaction and document submission module;
applying filtering techniques to identify relevant documents based on predefined rules including subject line and sender by the document processing and integration module;
processing the identified documents using optical character recognition (OCR) and artificial intelligence to extract data from the documents by the document processing and integration module;
triggering error flagging for invalid and incomplete data fields, sending flagged data to the computing device by the document processing and integration module;
enabling the user to manually review and correct errors, further transmitting the corrected data to the document processing and integration module;
validating and enriching extracted data against predefined business rules and external databases by applying the AI techniques to the corrected data to enhance data accuracy and completeness;
converting the extracted data into structured formats for integration with external systems by the document processing and integration module and securely storing the processed data in a cloud database; and
sending real-time alerts and generate reports for document processing status and system performance metrics to the user interaction and document submission module from the document processing and integration module, thereby enabling the user to track workflow efficiency and make data-driven decisions.

20. A computer program product comprising a non-transitory computer-readable medium having a computer-readable program code embodied therein to be executed by one or more processors, said program code including instructions to:
enable a user upload documents with along with a message, monitor processing progress, and manually review flagged errors by the user interaction and document submission module on a computing device;
continuously checking, by a document processing and integration module executed on a cloud server communicatively coupled to the computing device over a network, for incoming messages from the user interaction and document submission module;
apply filtering techniques to identify relevant documents based on predefined rules including subject line and sender by the document processing and integration module;
process the identified documents using optical character recognition (OCR) and artificial intelligence to extract data from the documents by the document processing and integration module;
trigger error flagging for invalid and incomplete data fields, sending flagged data to the computing device by the document processing and integration module;
enable the user to manually review and correct errors, further transmitting the corrected data to the document processing and integration module;
validate and enriching extracted data against predefined business rules and external databases by applying the AI techniques to the corrected data to enhance data accuracy and completeness;
convert the extracted data into structured formats for integration with external systems by the document processing and integration module and securely storing the processed data in a cloud database; and
send real-time alerts and generate reports for document processing status and system performance metrics to the user interaction and document submission module from the document processing and integration module, thereby enabling the user to track workflow efficiency and make data-driven decisions.
